(19) United States
(12) Patent Application Publication
(10) Pub. No.: US 2024/0145124 A1
(43) Pub. Date: May 2, 2024

(54) WATER-PROOF STRUCTURE FOR ELECTRIC WIRE AND WATER-PROOF METHOD FOR ELECTRIC WIRE

(71) Applicant: Yazaki Corporation, Tokyo (JP)

(72) Inventors: Eiichi Tohyama, Shizuoka (JP); Michitake Masuda, Shizuoka (JP); Hideyuki Wada, Shizuoka (JP)

(73) Assignee: Yazaki Corporation, Tokyo (JP)

(21) Appl. No.: 18/495,923

(22) Filed: Oct. 27, 2023

(30) Foreign Application Priority Data
Oct. 31, 2022 (JP) 2022-174195

(51) Int. Cl. H01B 7/282; H01B 3/44; H01B 7/38

(52) U.S. Cl. CPC H01B 7/282; H01B 3/44; H01B 7/385; H01R 4/72

(57) ABSTRACT

A water-proof structure for electric wire includes a pair of electric wires, a pair of first positioning members, and a molded body. The electric wires include core wire exposed parts each in which a core wire is exposed by peeling off an insulation sheath. The first positioning members hold the electric wires spaced from each other and position the electric wires in a height direction of the electric wires. The molded body is molded with resin such that the core wire exposed parts are sealed in a state where the electric wires are positioned by the first positioning members.

### CROSS-REFERENCE TO RELATED APPLICATIONS

The present application is based on and claims the benefit of priority from the prior Japanese Patent Application No. 2022-174195, filed on Oct. 31, 2022, the entire contents of which are incorporated by reference herein.

### TECHNICAL FIELD

The disclosure relates to a water-proof structure for electric wire and a water-proof method for electric wire.

### BACKGROUND

As a conventional water-proof structure for electric wire, there has been known a water-proof structure for electric wire described in Patent Document 1 (JP 2009-152012 A). In the water-proof structure for electric wire described in Patent Document 1, a heat-shrinkable tube is put over an intermediate portion of an electric wire which includes a core wire exposed part where an insulation sheath of the electric wire is peeled off and two parts of the insulation sheath adjacent to the core wire exposed part. Then, the heat-shrinkable tube is heated to melt a heat-melting water-proof agent laminated inside the heat-shrinkable tube, which allows the heat-melting water-proof agent to penetrate among a plurality of strands of a core wire in the core wire exposed part.

### SUMMARY

However, the conventional water-proof structure for electric wire requires a process in which the heat-shrinkable tube is heated to shrink, which causes variations depending on conditions, resulting in quality issues. Further, because the process relies on human labors, it cannot be labor-saving and is therefore more expensive. Furthermore, it cannot be used under environmental conditions where the heat-melting water-proof agent in an inner layer of the heat-shrinkable tube melts before it is heated.

The disclosure has been made in view of such a conventional problem, and it is an object of the disclosure to provide a water-proof structure for electric wire and a water-proof method for electric wire that can improve quality and reduce labors and costs.

A water-proof structure for electric wire in accordance with a first aspect includes: a pair of electric wires that include core wire exposed parts each in which a core wire is exposed by peeling off an insulation sheath; a pair of first positioning members that hold the electric wires spaced from each other and position the electric wires in a height direction of the electric wires; and a molded body that is molded with resin such that the core wire exposed parts are sealed in a state where the electric wires are positioned by the first positioning members.

A water-proof method for electric wire in accordance with a second aspect includes: peeling off insulation sheaths of a pair of electric wires to form core wire exposed parts each in which a core wire is exposed; connecting lead wires of an electronic component to the core wire exposed parts of the electric wires; mounting a pair of first positioning members and a pair of second positioning members to the electric wires and the electronic component to position the electric wires and the electronic component; and mold-forming with resin a molded body such that the electric wires including connection portions of the core wire exposed parts and the lead wires of the electronic component are sealed with the resin in a state where the electric wires and the electronic component are positioned by the first positioning members and the second positioning members.

According to the disclosure, it is possible to provide a water-proof structure for electric wire and a water-proof method for electric wire that can improve quality and reduce labors and costs.

### BRIEF DESCRIPTION OF DRAWINGS

FIG. 1 is a front view illustrating one example of an electric wire assembly used in a water-proof structure for electric wire according to a first embodiment.

FIG. 2A is a perspective view of one mode of each of a first positioning member and a second positioning member used in the water-proof structure for electric wire according to the first embodiment.

FIG. 2B is a perspective view of another mode of the second positioning member used in the water-proof structure for electric wire according to the first embodiment.

FIG. 3 is a front view of a state before a part of the electric wire assembly is received in a mold and then mold-forming is performed.

FIG. 4 is a front view of the water-proof structure for electric wire according to the first embodiment.

FIG. 5 is a plan view of the water-proof structure for electric wire according to a second embodiment.

### DETAILED DESCRIPTION

Hereinafter, a water-proof structure for electric wire and a water-proof method for electric wire according to embodiments will be described in detail with reference to the drawings.

### First Embodiment

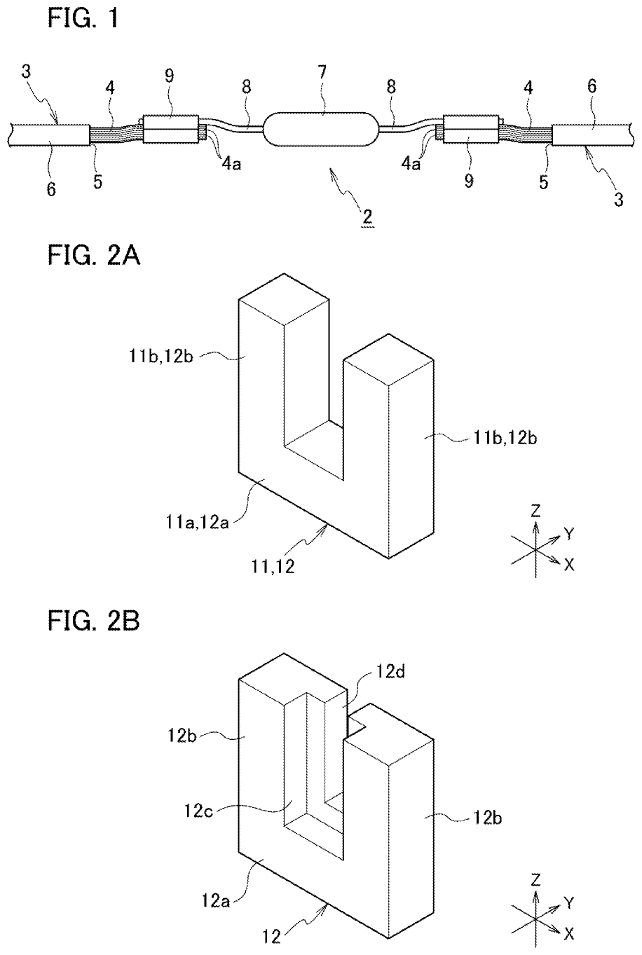

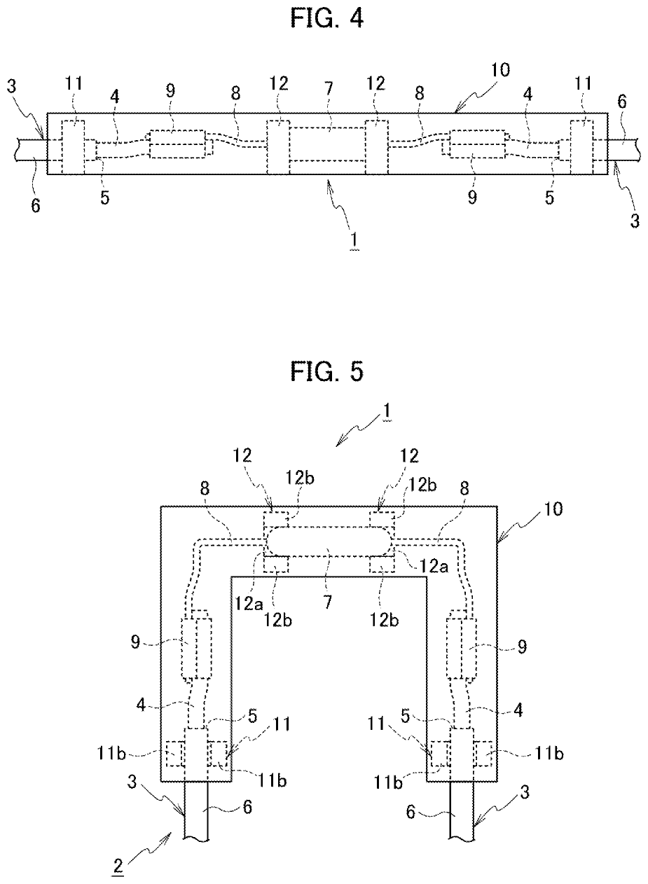

As illustrated in FIG. 1, an electric wire assembly 2 used in a water-proof structure 1 for electric wire includes a pair of electric wires 3, 3, and a resistor (electronic component) 7 disposed between the end portions of the electric wires 3, 3. As illustrated in FIG. 1 and FIG. 4, the water-proof structure 1 for electric wire includes the electric wire assembly 2, a pair of first positioning members 11, 11 that hold the electric wires 3, 3 of the electric wire assembly 2 spaced from each other, a pair of second positioning members 12, 12 that hold the resistor 7 of the electric wire assembly 2 spaced from each other, and a molded body 10 that is molded with resin to seal core wire exposed parts 5, 5 of the electric wires 3, 3 which will be described later. One of the electric wires 3, 3 of the water-proof structure 1 for electric wire is connected to a device such as an ECU (Electric Control Unit) performing a control or the like of a plurality of electric components mounted in a vehicle (not illustrated). The other of the electric wires 3, 3 of the water-proof structure 1 for electric wire is connected to a component such as a non-water-proof terminal.

As illustrated in FIG. 1, each of the electric wires 3, 3 of the electric wire assembly 2 includes a core wire 4 in which a plurality of strands 4a is twisted, and an insulation sheath 6 made of insulation resin covering the core wire 4. Each of the end portions of the electric wires 3, 3 facing each other has a core wire exposed part 5 where the insulation sheath 6 is peeled off and the core wire 4 is exposed. The core wire exposed parts 5, 5 are electrically connected to lead wires 8, 8 extending outward from both ends of the resistor 7 via conductive joint terminals 9, 9 by fixing the lead wires 8, 8 to the core wire exposed parts 5, 5 with the joint terminals 9, 9 by applying pressure. The core wires 4, 4 are made of a metallic material such as copper, copper alloy, or aluminum alloy, for example.

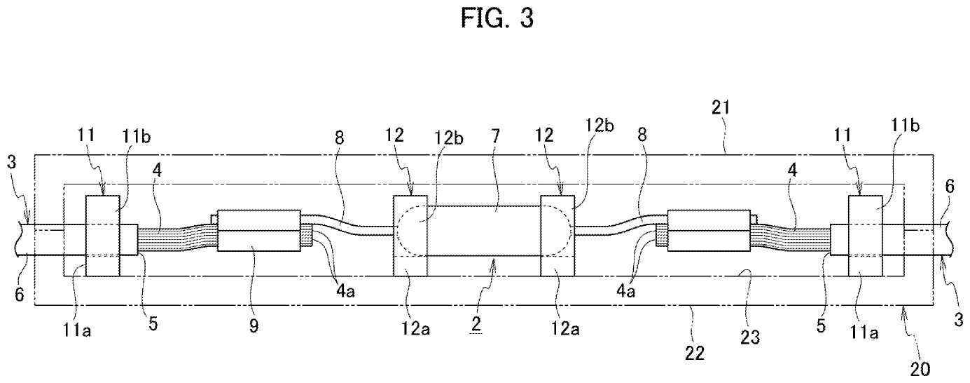

As illustrated in FIG. 3 and FIG. 4, the water-proof structure 1 for electric wire includes the first positioning members 11, 11 that hold the electric wires 3, 3 spaced from each other, and position the electric wires 3, 3 in a height direction of the electric wires 3, 3 before performing mold-forming with resin. As illustrated in FIG. 3 and FIG. 4, the first positioning members 11, 11 hold the insulation sheaths 6, 6 of the electric wires 3, 3 to position the electric wires 3, 3 in the height direction of the electric wires 3, 3. The water-proof structure 1 for electric wire includes the second positioning members 12, 12 that hold the resistor 7 spaced from each other, and position the resistor 7 in a height direction of the resistor 7 before performing mold-forming with resin. As illustrated in FIG. 3 and FIG. 4, the second positioning members 12, 12 directly hold both end portions of the resistor 7 to position the resistor 7 in the height direction of the resistor 7. The second positioning members 12, 12 may hold the lead wires 8, 8 to position the resistor 7 in the height direction of the resistor 7.

As illustrated in FIG. 2A, each of the first positioning members 11, 11 made of resin is formed in a substantially U-shape, and includes a bottom portion 11a and side portions 11b, 11b. It is noted that an X-direction illustrated in FIG. 2A corresponds to a length direction of the bottom portion 11a. A Y-direction illustrated in FIG. 2A corresponds to a width direction of the bottom portion 11a and is perpendicular to the X direction. A Z-direction illustrated in FIG. 2A corresponds to a height direction of the bottom portion 11a and is perpendicular to the X-direction and the Y-direction. The side portions 11b, 11b are installed on both end portions of the bottom portion 11a in the length direction (X-direction) of the bottom portion 11a in a standing manner. An interval between the side portions 11b, 11b in the length direction (X-direction) of the bottom portion 11a is constant along the width direction (Y-direction) of the bottom portion 11a. The positioning of each electric wire 3 in the height direction of the electric wire 3 can be performed by adjusting a height of the bottom portion 11a. The side portions 11b, 11b prevent each electric wire 3 from shifting in the length direction (X-direction) of the bottom portion 11a.

Similarly, as illustrated in FIG. 2A, each of the first positioning members 12, 12 made of resin is formed in a substantially U-shape, and includes a bottom portion 12a and side portions 12b, 12b. It is noted that an X-direction illustrated in FIG. 2A corresponds to a length direction of the bottom portion 12a. A Y-direction illustrated in FIG. 2A corresponds to a width direction of the bottom portion 12a and is perpendicular to the X direction. A Z-direction illustrated in FIG. 2A corresponds to a height direction of the bottom portion 12a and is perpendicular to the X-direction and the Y-direction. The side portions 12b, 12b are installed on both end portions of the bottom portion 12a in the length direction (X-direction) of the bottom portion 12a in a standing manner. An interval between the side portions 12b, 12b in the length direction (X-direction) of the bottom portion 12a is constant along the width direction (Y-direction) of the bottom portion 12a. The positioning of the resistor 7 in the height direction of the resistor 7 can be performed by adjusting a height of the bottom portion 12a. The side portions 12b, 12b prevent the resistor 7 from shifting in the length direction (X-direction) of the bottom portion 12a.

As illustrated in FIG. 2B, each of the second positioning members 12, 12 may have a wide concave portion 12c provided between the side portions 12b, 12b at one side in the width direction (Y-direction) of the bottom portion 12a, and a narrow concave portion 12d between the side portions 12b, 12b, which is narrower than the concave portion 12c and contacts the concave portion 12c, at the other side in the width direction (Y-direction) of the bottom portion 12a. A distance between the side portions 12b, 12b in the length direction (X-direction) of the bottom portion 11a at one side in the width direction (Y-direction) of the bottom portion 12a is larger than a distance between the side portions 12b, 12b in the length direction (X-direction) of the bottom portion 11a at the other side in the with direction (Y-direction) of the bottom portion 12a. In this case, the resistor 7 is held by the concave portions 12c, 12c of the second positioning members 12, 12 and the lead wires 8, 8 are held by the concave portions 12d, 12d of the second positioning members 12, 12. Thus, the resistor 7 may be held by the concave portions 12c, 12c of the second positioning members 12, 12 and the lead wires 8, 8 may be held by the concave portions 12d, 12d of the second positioning members 12, 12 to position the resistor 7 in the height direction of the resistor 7.

Next, a manufacturing procedure of the water-proof structure 1 for electric wire will be described below with reference to FIG. 1, FIG. 3 and FIG. 4.

In the manufacturing procedure of the water-proof structure 1 for electric wire, a core wire exposure process is first performed. In the core wire exposure process, the insulation sheath 6 of each of the electric wires 3, 3 is peeled off at the end portion of each of the electric wires 3, 3 to form the core wire exposed part 5 in which the core wire 4 including the plurality of strands 4 is exposed.

Next, as illustrated in FIG. 1, a parts connection process is performed. In the parts connection process, the lead wires 8, 8 of the resistor 7 are connected to the core wire exposed parts 5, 5 of the electric wires 3, 3, respectively. More specifically, the lead wires 8, 8 extending outward from both ends of the resistor 7 are crimped to the core wire exposed parts 5, 5, which are formed at the end portions of the electric wires 3, 3, with the joint terminals 9, 9 such that the lead wires 8, 8 are electrically connected to the core wire exposed parts 5, 5. Thereby, the electric wire assembly 2 is assembled.

Next, a positioning process is performed. In the positioning process, the first positioning members 11, 11 and the second positioning members 12, 12 are respectively mounted to the electric wires 3, 3 and the resistor 7 to position the electric wires 3, 3 and the resistor 7 in the height direction of the electric wires 3, 3 and the resistor 7 before mold-forming with resin is performed.

Finally, as illustrated in FIG. 4, a mold-forming process is performed. In the mold-forming process, the end portions of the electric wires 3, 3 including connection portions of the core wire exposed parts 5, 5 and the lead wires 8, 8 of the resistor 7 is sealed with resin in a state where the electric wires 3, 3 are positioned by the first positioning members 11, 11 and the resistor 7 is positioned by the second positioning members 12, 12. As illustrated in FIG. 3, the electric wires 3, 3 and the resistor 7 of the electric wire assembly 2, which are positioned in the height direction of the electric wires 3, 3 and the resistor 7 by the first positioning members 11, 11 and the second positioning members 12, 12, are fitted into a cavity 23 of a mold 20 consisting of an upper mold 21 and a lower mold 22. Then, melted resin is injected into the cavity 23 to seal with resin the end portions of the electric wires 3, 3 including the connection portions of the core wire exposed parts 5, 5 and the lead wires 8, 8 of the resistor 7, which mold-forms the molded body 10. When the melted resin hardens, the water-proof structure 1 for electric wire illustrated in FIG. 4 is completed.

Thus, in manufacturing the water-proof structure 1 for electric wire, by respectively holding the electric wires 3, 3 and the resistor 7 by the first positioning members 11, 11 and the second positioning members 12, 12 to position the electric wires 3, 3 and the resistor 7 in the height direction of the electric wires 3, 3 and the resistor 7, the core wire exposed part 5, 5 can be placed at an axial center position of the molded body 10 with a substantially cylindrical shape. In other words, the end portions of the electric wire 3, 3 can be prevented from being pulled to one side by a flow of melted resin during molding to protrude from the resin molded portion, thereby, preventing the electric wires 3, 3 from being unevenly distributed in the hardened resin to improve quality.

Furthermore, molding with hard resin eliminates a need for conventional protection using the heat-shrinkable tube with a heat-melting water-proofing agent laminated inside the heat-shrinkable tube, which reduces labors and costs and allows use under high temperature conditions. In addition, since the pre-processing is completed simply by positioning the electric wires 3, 3 and the resistor 7 using the first positioning members 11, 11 and the second positioning members 12, 12, labors and costs are reduced accordingly.

### Second Embodiment

The water-proof structure 1 for electric wire in a second embodiment differs from the water-proof structure 1 for electric wire in the first embodiment in that a part of the electric wire assembly 2 bent in a substantially U-shape is sealed by mold-forming with resin (see FIG. 5). Since the other configurations are similar to those of the first embodiment, the same symbols are attached to the same configuration parts and detailed explanations are omitted.

In the present embodiment, in a state where (i) the lead wires 8, 8 of the resistor 7 each bent in a substantially L-shape are crimped to the core wire exposed parts 5, 5 of the electric wires 3, 3 with the joint terminals 9, 9 and (ii) the electric wires 3, 3 and the resistor 7 are respectively positioned by the first positioning members 11, 11 and the second positioning members 12, 12, the electric wires 3, 3 and the resistor 7 are fitted into a cavity of a mold with a substantially U-shape. Then, melted resin is injected into the cavity of the mold to seal with resin the end portions of the electric wires 3, 3 including the connection portions of the core wire exposed parts 5, 5 and the lead wires 8, 8 of the resistor 7 of the electric wire assembly 2 bent in a substantially U-shape, which mold-forms (blade-forms) the molded body 10. This produces the same action and effect as the first embodiment. Especially, the water-proof structure 1 for electric wire can be installed in a small space.

The above describes the water-proof structure for electric wire and the water-proof method for electric wire according to the embodiments, but those are not limited to the embodiments, and various modification are possible within the gist of the embodiments.

According to the modified example of the second embodiment, the electric wire assembly 2 bent in the substantially U-shape is formed by bending each of the lead wires 8, 8 of the resistor 7 in the substantially L-shape, but the electric wire assembly 2 bent in the substantially U-shape may be formed by bending each of parts of the electric wires 3, 3 adjacent to both sides of the lead wires 8, 8 in a substantially L-shape.

According to the first embodiment and the second embodiment, the resistor 7 is used as the electronic component, but the electronic component is not limited to the resistor 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A water-proof structure for electric wire comprising:
a pair of electric wires that include core wire exposed parts each in which a core wire is exposed by peeling off an insulation sheath;
a pair of first positioning members that hold the electric wires spaced from each other and position the electric wires in a height direction of the electric wires; and
a molded body that is molded with resin such that the core wire exposed parts are sealed in a state where the electric wires are positioned by the first positioning members.

2. The water-proof structure for electric wire according to claim 1,
wherein each of the first positioning members is formed in a substantially U-shaped.

3. The water-proof structure for electric wire according to claim 1, further comprising:
an electronic component of which lead wires are connected to the core wire exposed parts.

4. The water-proof structure for electric wire according to claim 3, further comprising:
a pair of second positioning members that hold the electronic component spaced from each other and position the electronic component in a height direction of the electronic component.

5. A water-proof method for electric wire comprising:
peeling off insulation sheaths of a pair of electric wires to form core wire exposed parts each in which a core wire is exposed;
connecting lead wires of an electronic component to the core wire exposed parts of the electric wires;
mounting a pair of first positioning members and a pair of second positioning members to the electric wires and the electronic component to position the electric wires and the electronic component; and
mold-forming with resin a molded body such that the electric wires including connection portions of the core wire exposed parts and the lead wires of the electronic component are sealed with the resin in a state where the electric wires and the electronic component are positioned by the first positioning members and the second positioning members.
